(19) United States
(12) Patent Application Publication
(10) Pub. No.: US 2006/0025002 A1
(43) Pub. Date: Feb. 2, 2006

(54) TEM MEMS device holder and method of fabrication

(75) Inventors: Ming Zhang, Boise, ID (US); Ivan Petrov, Champaign, IL (US); Jianguo Wen, Champaign, IL (US); Eric A. Stach, West Lafayette, IN (US); Leslie H. Allen, Champaign, IL (US); Ian Robertson, Champaign, IL (US); Eric A. Olson, Champaign, IN (US)

Correspondence Address: Steven P. Fallon;GREER, BURNS & CRAIN, LTD., Suite 2500, 300 South Wacker Drive, Chicago, IL, 60606, US

(73) Assignee: The Board of Trustees of the University of Illinois

(21) Appl. No.: 11/192,300

(22) Filed: Jul. 28, 2005

Related U.S. Application Data
(60) Provisional application No. 60/591,716, filed on Jul. 28, 2004.

(51) Int. Cl. H01R 13/62

(52) U.S. Cl. 439/329

(57) ABSTRACT

A device and method for fabricating a device holder for use with a standard holder body of a transmission electron microscope for use with in situ microscopy of both static and dynamic mechanisms. One or more electrical contact fingers is disposed between a baseplate and a frame, with a MEMS device making contact with the electrical contact fingers. A connector is provided to matingly engage the transmission electron microscope and the device holder to couple the device holder to the transmission electron microscope. Once clamped between the baseplate and frame, the electrical contact fingers may be separated from the template.

### PRIORITY CLAIM

This application claims the benefit of U.S. Provisional Application Ser. No. 60/591,716, filed Jul. 28, 2004, under 35 U.S.C. § 19.

### STATEMENT OF GOVERNMENTAL INTEREST

This invention was made with Government support under Contract Number DEFG02-91-ER45439 and DEAC03-76SF00098 awarded by the Department of Energy (DOE). The Government has certain rights in the invention.

### FIELD OF THE INVENTION

A field of the invention is transmission electron microscopy (TEM).

### BACKGROUND OF THE INVENTION

Transmission electron microscopy (TEM) is an important technique to achieve microanalysis down to atomic level. Commonly used TEM techniques are bright field (BF) image, dark field (DF) image, high-resolution (HRTEM) image, and selected area diffraction (SAD). An analytical TEM is capable of additional complex microanalyses, e.g., convergent beam electron diffraction (CBED), z-contrast imaging (also called STEM), electron energy loss spectrum (EELS), energy disperse spectrum (EDS), etc.

A TEM is a relatively complex instrument, and requires precise positioning of a sample. The pole pieces of the microscope have to be positioned closely. A small gap exists between the pole pieces of a TEM, e.g. ˜5 mm, and a sample must be positioned in the middle of the gap, known as the eucentric height of the microscope. This places limitations on the types of samples and sample holders that may be examined. Accordingly, the full power of TEM techniques remains limited by the type of samples that are typically investigated, namely those that can be placed in the sample position.

### SUMMARY OF THE INVENTION

An exemplary embodiment of the invention is a MEMS device holder for use with a TEM. The device holder includes an aligned set of electrical contact fingers sandwiched between substrates and configured and arranged to contact a MEMS device disposed within the holder. The number of electrical contact fingers may vary to suit individual applications, and may for example, include four contacts or eight contacts.

The invention also provides a method of forming a device of the invention, by providing an electrical contact template, portions of which electrical contact template may be selectively etched away to fabricate electrical contact fingers bound at one end by a portion of the unetched template. The electrical contact fingers are then sandwiched between substrates of the device holder in such a manner as to promote alignment and contact between the electrical contact fingers and a MEMS device. When the electrical contact fingers are sandwiched with a MEMS device between the substrates, and when the MEMS device and the electrical contact fingers are properly positioned, portions of the template may be removed to release the electrical spring fingers at the bound ends thereof.

### BRIEF DESCRIPTION OF THE DRAWINGS

FIG. 1 is an exploded perspective view of a device holder according to a first embodiment of the invention;

FIG. 2 is a top elevational view of the device holder illustrated in FIG. 1;

FIG. 3 is a side elevational view of the device holder illustrated in FIG. 1 in contact with a TEM wire;

FIG. 4 is a top elevational view of an exemplary MEMS devices that can be used with the device holder of FIG. 1;

FIG. 5A is a top elevational view of a device holder according to a second embodiment of the invention;

FIG. 5B is a side elevational view of the device holder illustrated in FIG. 5A;

FIG. 6 is a top elevational view of an electrical contact template with the device holder of FIG. 5A;

FIG. 7 is a top elevational view of the electrical contact template of FIG. 6;

FIG. 8 is a graph illustrating heat capacity measurements on a Bi nanoparticle sample using a device holder according to embodiments of the invention, with an inset of bright field TEM micrograph of the particles;

FIG. 9 is a graph illustrating use of a nanocalorimeter as a microheater according to embodiments of the invention; and

FIG. 10 is an exploded perspective view of a third embodiment of the device holder of the invention.

### DETAILED DESCRIPTION OF THE PREFERRED EMBODIMENTS

There has been a growing tendency to use the transmission electron microscope (TEM) as a dynamic research tool to study atomic-scale mechanisms of complex materials processes. However, broad use of the TEM for this purpose has been limited by the relatively small space available in the objective lens pole piece of the TEM for incorporating a device holder.

In various embodiments of the invention, microelectromechanical systems (MEMS) devices are configured to be held in the sample position required by a TEM, and the invention includes a device holder that positions a MEMS device in the sample position of the TEM. MEMS devices, include, for example, miniaturized sensors and actuators for designed critical applications, and also may include fluid communication channels and other operations that can deliver samples of interest to an observation position in a TEM. The invention provides a device holder and MEMS devices that can deliver samples, including dynamic samples, to the observation position in a TEM microscope. The invention provides the ability to monitor the dynamic response of materials to external stimuli, atomic-scale observation of nanostructure synthesis, as well as in situ multi-probe measurement of the properties of individual nanostructures.

Features on a MEMS device are usually much larger than the areas typically observed in a TEM. Through the invention, a MEMS device can be operated during TEM operation and analysis, permitting critical experiments to be conducted in ways that are not achievable with a static sample that is placed on a conventional sample holder in a TEM microscope. For example, using direct observation, dynamic processes may be observed with TEM.

Embodiments of the instant invention provide a standardized specimen holder, or device holder, that promotes operation of a MEMS device inside a TEM, thereby facilitating in situ microscopy by employing micro- and nano-lithographic techniques and MEMS to add functionality of the specimen holder. Embodiments of the invention are especially advantageous in that the design is simple, and permit a plurality of signal lines, e.g., eight or more, disposed on the device holder. Devices of the invention provide enhanced capabilities to stimulate and probe system response as compared to conventional approaches. Exploiting MEMS technology allows for high precision electrical, thermal and mechanical manipulation of individual nanostructures while simultaneously measuring properties of a sample, and carrying out real-time, atomic-resolution imaging, electron diffraction, and spectroscopy.

Embodiments of the invention include a TEM microscope and methods for dynamic TEM microscopy. In a method of the invention, a TEM microscope is operated with a dynamic sample. The dynamic sample is processed by an active MEMS control system during TEM examination to obtain dynamic information regarding the sample.

Other embodiments of the invention provide for establishing a simple, reliable and robust method for making electrical connections between the device holder and external controllers. Up to twelve electrical signals are provided on a device holder for use with a standard holder base. It should be appreciated, however, that the invention contemplates use with additional electrical signals in applications where an alternative number is necessary or desired.

While particular exemplary embodiments may be shown and described, a device of the invention is generally a MEMS TEM device holder. The device holder includes a precisely aligned set of electrical contact fingers, where the number of electrical contact fingers may vary to suit individual applications. The electrical contact fingers are sandwiched between substrates to make electrical contact with a MEMS device.

In a method of forming a device of the invention, electrical contact fingers having a particular number and configuration are formed by lithography or comparable precision material removal process or direct pattern deposition process on an electrical contact template, such as a copper substrate. Thus, the copper electrical contact template includes electrical contact fingers bound at one end, and portions of template may be removed subsequent to coupling of the electrical contact fingers to the device holder.

The precision formation process promotes positioning of the electrical contact fingers for the particular MEMS device that will be used with the device holder. When the electrical contact fingers are sandwiched between substrates, and the MEMS device and the electrical contact fingers are properly positioned, portions of the electrical contact template may be removed to release the bound ends of the electrical contact fingers of the template. Thus, the electrical contact fingers are left securely and precisely aligned between the substrates.

While it is contemplated that the invention may be used with any standard TEM, for purposes of illustration only, embodiments of the invention will be shown and described in combination with a TEM known as the JEOL 2010. The standard JEOL 2010 TEM double holder tip assembly is about 25.8 mm long, 12.7 mm wide, and 2 mm thick. The TEM specimen should be preferably be placed at 6 mm to the front edge and at the center of the other two directions of the tip. However, extending an additional one millimeter on the tip front will not interfere with performance of the TEM or device holder operating therewith. The available space in a TEM for the MEMS device and the contacts disposed thereon, as well as the sample locking mechanism, is therefore fixed.

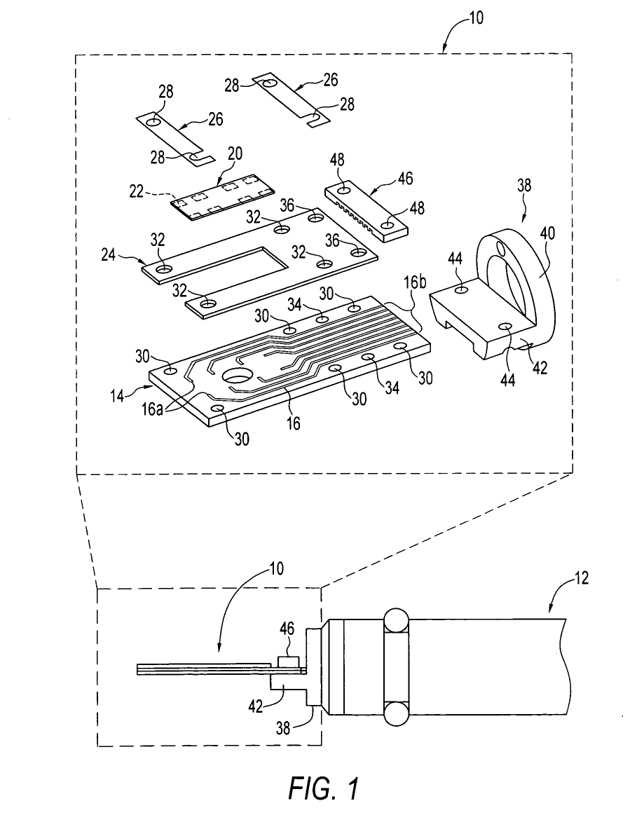

Turning to FIG. 1, a device holder according to a first preferred embodiment is illustrated and designated generally at 10. The device holder 10 may be configured to suit individual applications, but may advantageously be configured to be assembled to, and operate with, a standard specimen holder body, such as that designated generally at 12.

The device holder 10 includes a generally rectangular baseplate, designated generally at 14 is provided. The baseplate 14 is preferably made from anodized aluminum (Al) or titanium and preferably includes a thickness of approximately 1 mm. In the JEOL 2010 TEM, an underside of the baseplate 14 faces an electron beam, and therefore, the underside of the baseplate is preferably conductive to prevent charging. All materials of the device holder 10 are preferably non-magnetic and vacuum compatible.

Anywhere from one to eight or more electrical contact fingers 16 are provided with the device holder, and may be etched using standard lithography or comparable precision material removal process, or direct pattern deposition process. In the instant embodiment, the electrical contact fingers are formed from a beryllium copper (CuBe) alloy plated with Au for corrosion resistance and low contact resistance. The resistance between the individual contacts and the baseplate 14 is approximately 100 MΩ.

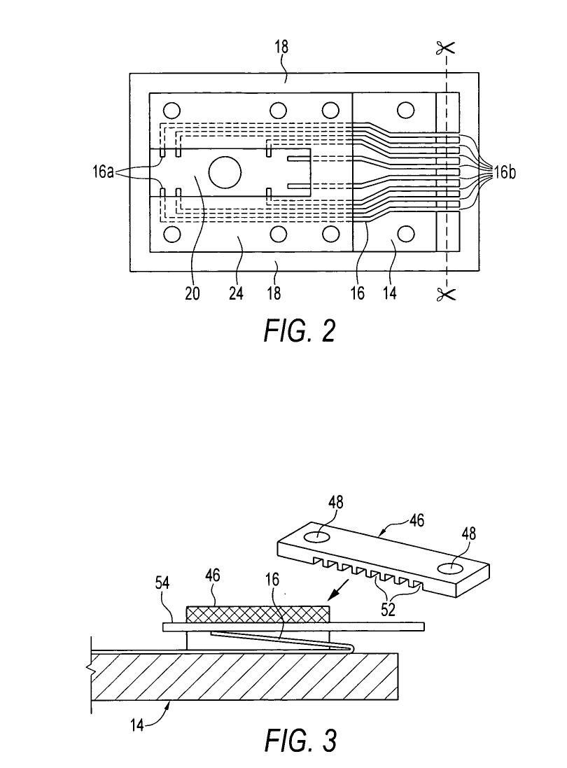

Each set of electrical contact fingers 16 is preferably fabricated as a single piece to precisely control alignment and assembly, which when compared to wire bonding, does not restrict sample exchange with a protruding wire that occupies additional space. To this end, an electrical contact template 18 (FIG. 2) is provided, having dimensions corresponding to that of the baseplate 14. Portions of the electrical contact template 18 are etched to fabricate one or more electrical contact fingers 16, where each of the electrical contact fingers includes a free distal end 16a. Once the electrical contact fingers 16 of the template 18 are clamped in place, portions of the template 18 unnecessary to electrical contact with either a MEMS device 20 or the TEM may subsequently be removed.

The device holder 10 of the invention is configured to operate with the MEMS device 20. The MEMS device includes contact pads 22 disposed on an underside thereof, where the contact pads may assume a plurality of configurations depending on the particular application. Accordingly, depending on the particular configuration of the MEMS device 20 used in a particular application, the number and configuration of electrical contact fingers 16 align with the contact pads 22. Thus, in the instant embodiment, where the MEMS device 20 includes eight contact pads 22, the electrical contact template 18 is etched to include eight electrical contact fingers 16 configured to correspond to the contact pads of the MEMS device.

To hold the electrical contact fingers 16 in place and to promote alignment of the MEMS device 20 within the device holder 10, the electrical contact fingers are preferably sandwiched between the baseplate 14 and a frame 24, which is a generally U-shaped structure, preferably made from anodized Al and having a thickness of approximately 0.5 mm. As illustrated in FIG. 3, the electrical contact fingers 16 are preferably configured to be spring fingers that may be fabricated by standard lithography techniques and may be custom-designed to suit individual applications.

The electrical contact fingers 16 extend upwardly from the baseplate 14 toward the frame 24, and are slightly bent at the distal ends 16a thereof such that when the electrical contact fingers are clamped, they become immobilized. The slightly bent distal ends 16a also provide a gentle upward biasing force to promote contact between the electrical contact fingers 16 and the MEMS device 20. As a practical matter, after the electrical contact fingers 16 are clamped, other portions of the template 18 may be removed to release the electrical contact fingers, such as by cutting as illustrated in FIG. 2.

Retainers 26 are also preferably provided, such as one or more spring clips. For example, the retainers 26 are preferably elongated, rectangular spring members having an opening 28 disposed at either end. As such, each of the baseplate 14 and frame 24 preferably include corresponding openings 30, 32 configured and arranged to align with the openings 28 of the retainers 26. Nonmagnetic fasteners (not shown), such as aluminum or titanium screws, are accordingly provided to engage the openings 28, 30, 32 to maintain alignment and engagement of the baseplate 14, frame 24 and retainers 26. The baseplate 14 and frame 24 may include an additional pair of corresponding openings 34, 36, through which additional nonmagnetic fasteners (not shown) may extend to maintain the baseplate and frame in alignment.

Meanwhile, the MEMS device 20 is disposed within a generally rectangular shaped opening of the U-shaped frame 24, and sandwiched between the baseplate 14 and the retainers 26.

A connector 38 is also preferably provided to couple the device holder 10 to the holder body 12. The connector 38 includes a ring body 40 with a platform 42 having a generally planar top surface and extending outwardly in a direction perpendicular to a diameter of the ring body. The platform 42 includes at least one and preferably two openings 44 extending therethrough. Furthermore, an end plate 46 is also preferably provided to promote coupling of the device holder 10 to the holder body 12, where the end plate is a generally rectangular anodized Al member having openings 48 extending through either end. Corresponding openings 50 disposed at an end of the baseplate 14 are configured and arranged to overlap the openings 48 of the end plate 46.

Thus, to couple the device holder 10 to the holder body 12, the platform 42 is sandwiched between the end plate 46 and an end of the baseplate 14, such that openings 44, 48, 50 are configured and arranged to correspond to one another. Nonmagnetic fasteners (not shown) may be provided to extend through the openings 44, 48, 50, thereby securely fastening the device holder 10 to the holder body 12 in predetermined alignment. Once assembled, the device holder 10 is dimensioned such that it is compatible with a conventional JEOL 2010 TEM holder.

The end plate 46 is preferably made of anodized Al, and includes a plurality of grooves 52 (best shown in FIG. 3) machined into its underside, which help align the electrical contact fingers 16 and clamp the electrical contact fingers in place along with one or more wires 54. The number of grooves 52 generally corresponds to a number of wires 54, wherein each wire is at least partially received within a corresponding one of the grooves such that the grooves align and retain the wires. Similarly, the number of grooves 52 and the corresponding number of wires 54 also generally correspond to the number of contact fingers 16 provided with a particular device holder 10. However, it is also anticipated that the number of wires 54 and number of grooves 52 may be disproportionate without affecting or departing from the operation of the device holder.

The one or more wires 54 make contact with the electrical contact fingers 16 at or near proximal ends 16b of the electrical contact fingers 16. As such, the grooves 52 of the baseplate 52 promote contact between the electrical contact fingers 16 and the wires 54. To enhance the contact, the proximal ends 16b may optionally be biased slightly upward, or be bent in a hair-pin shape, though neither configuration is required for maintaining contact.

The one or more wires 54 extend the length of the holder body 12 to an electrical connector (not shown). Because the baseplate 14, frame 24 and end plate 46 are all preferably composed of anodized Al, the aluminum oxide coating provides electrical insulation. The platform 42 of the connector 38 has a generally planar top surface that receives the baseplate 14 thereon. Optionally, very thin metal shims (not shown) may also be provided for making fine adjustments of less than 100 μm to the height of the device holder 10, wherein a desired number of metal shims are placed between the generally planar top surface of the platform 42 and the device holder 10.

The TEM holder body 12 is preferably machined from a single piece of phosphor bronze alloy. To easily make an ultrahigh-vacuum-quality seal, a standard 1.33 in., Varian-ConFlat-compatible flange is cemented onto an end with a vacuum compatible sealant. A standard electrical feedthrough is connected to the flange using a copper gasket.

While the size of the MEMS device 20 may be manipulated to suit individual applications, the MEMS devices are preferably configured to allow for integration of sensors and actuators, are robust enough for manipulation, and large enough to have surface area available for contact pads 22. Thus, while the area available for TEM observation on the MEMS device 20 is several square millimeters, similar to traditional samples, the device holder 10 should preferably be configured to accommodate MEMS devices large enough to incorporate all these features.

Contact pads 22 are preferably approximately 1×1 mm to promote reliable contact alignment during mounting. In the standard design of a JEOL 2010 TEM single-tilt holder, a sample is disposed at an end of a rod in an assembly approximately 26 mm long, 13 mm wide, and 2 mm thick. The space available for the MEMS device 18 plus the contact pads 22 is therefore fixed by these dimensions for this particular TEM. The MEMS device 20 size of approximately 5×10 mm is preferable, as it permits use of all the standard features of the TEM, including tilting of the stage and insertion of the objective aperture.

The MEMS devices 20 are usually thin silicon pieces generally rectangular in shape, with MEMS function groups fabricated on one side of the device. A “flipchip” configuration is preferred, which ensures that the investigated sample will be situated correctly at the eucentric height, although the MEMS devices may optionally be made from wafers of various thicknesses. In the instant embodiment, a portion of a Si substrate used to fabricate the device holder 10 is removed to create an electron transparent region. Flat, continuous surfaces may be incorporated into the MEMS device 20 by the use of a membrane, usually made of lower-residual-stress silicon nitride (SiNₓ). Membranes can be large, a few millimeters on a side, but can be as thin as 30 nm. Supports such as these, in the traditional 3-mm form factor, are even commercially available with SiNₓ thicknesses between 30 and 100 nm. Thin films or individual nanostructures, e.g., nanotube, nanowires, etc., may be spanned across gaps in the silicon substrates and biased electrically and/or mechanically while performing TEM imaging and analysis.

For example, a MEMS-based calorimeter having the required dimensions may be generated in accordance with the invention. The nanocalorimeter (not shown) is fabricated with a thin (30±0.4 nm) SiNₓ membrane. SiNₓ is transparent to the electron beam, and provides a uniform, low-noise support suitable for the imaging of small features. A metal strip, such as Al and Au, (50 nm thick and 500 μm wide) is patterned on top of the SiNₓ to act as a precision thermometer.

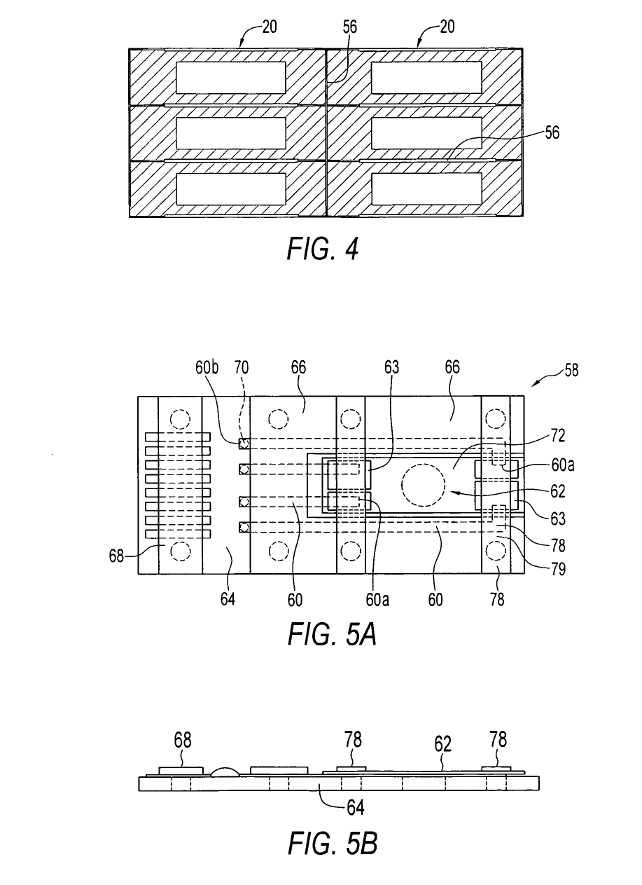

These electron-transparent MEMS devices, like conventional TEM samples, are very fragile. It is important that the MEMS device 20 is capable of being mounted and removed from the holder body 12 gently and reliably. To that end, the MEMS devices may be fabricated with “cleave lines,” 56 as illustrated in FIG. 4, where cleave lines are preferably incorporated into the MEMS design process to accurately control the outside dimensions of the MEMS device 20 without the need to mechanically cut the individual devices, keeping breakage to a minimum. Better control of the size of the finished device also promotes alignment of the MEMS device 20 in the TEM holder body 12. The cleave lines 56 may be fabricated by standard dry or wet etching techniques and can be included in an existing MEMS fabrication process, thus requiring no additional process steps.

Another embodiment of the invention is provided in FIGS. 5A-7, which illustrate a device holder 58 having four electrical contact fingers 60 disposed thereon. FIGS. 5A and 5B illustrate a method by which a MEMS device 62 makes contact with the device holder 58 via contact pads 63. The baseplate 64 is preferably an aluminum plate having an anodized top surface of 1 μm thick alumina to provide insulation. A frame 66 and end plate 68 are also preferably fabricated from aluminum plates, but instead have anodized bottom surfaces. The baseplate 64 and frame 66 and end plate 68 cooperatively engage one another to clamp the four electrical contact fingers 60, which are preferably beryllium copper spring fingers, and 0-80 aluminum or titanium screws are using to tighten the baseplate 64, frame 66 and end plate 68 together.

The electrical contact fingers 60 are preferably springy and slightly bent at their distal tips 60a to promote maintenance of alignment after they are clamped between the baseplate 64, frame 66 and end plate 68, and to promote contact with the MEMS device 62. While dimensions of the electrical contact fingers 60 may vary to suit individual applications, preferred dimensions are 0.1 mm thick, with 1 μm thick gold coating. Indium wire 70 is then temporarily used to connect the electrical contact fingers 60 for a simple test.

The electrical contact fingers 60 are slightly bent at the distal tips 60a to ensure good electrical contact to the MEMS device 62. A contact region 72 of the MEMS device 62 is preferably approximately 50 nm thick patterned metal. The MEMS device 62 faces the baseplate 64, and is biased slightly upwardly by the electrical contact fingers 60 to prevent damage to the MEMS device by accidental contact with the baseplate. The MEMS device 62 is also biased toward the baseplate 64, and thereby held in position, by a pair of retainers 74, which are preferably relatively thicker beryllium copper springs. In this manner, the position of the MEMS device 62 is fixed, and contact is maintained.

The frame 66 preferably includes a U-shaped recess that also promotes alignment of the MEMS device 62 therein. Contact resistance is less than 1 Ω.

All materials of the device holder 58 are preferably non-magnetic and vacuum compatible. When the device holder 58 is inserted into the TEM, the device holder is upside down in the TEM. The conductive surface faces the electron beam and the MEMS device 62 is protected underneath. Therefore, common problems are alleviated, such as slow pumping speed caused by virtual leaks, deflection of the electron beam caused by magnetic materials, and charging on insulated surfaces by the electron beam of the TEM.

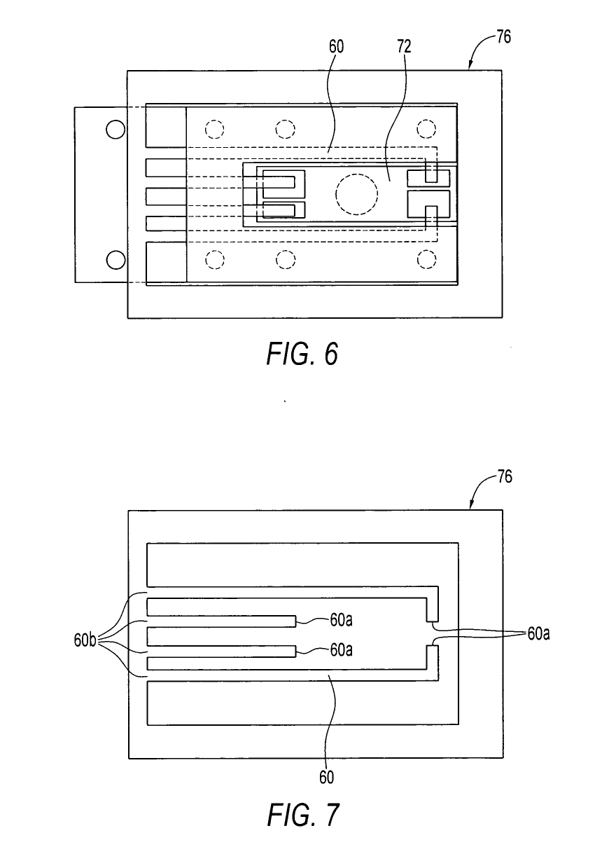

Fabrication of the electrical contact fingers 60, as well as assembly of the electrical contact fingers, is illustrated in FIGS. 6 and 7. As discussed in previous embodiments, the electrical contact fingers 60 may be fabricated by etching an electrical contact template 76 using standard lithography-etching techniques that promote precise control of the contact position and configuration, which may vary to suit individual applications.

As with previous embodiments, the electrical contact template 76 is preferably a copper substrate from which electrical contact fingers 60 are etched, and supports the electrical contact fingers and maintains the electrical contact fingers in alignment. The template 76 is dimensioned such that it precisely aligns the electrical contact fingers 60 in a predetermined manner that corresponds to the MEMS device 62 used with the device holder 58. In the instant embodiment, for example, a length of the template 76 is approximately 26.3 mm, a width is approximately 18 mm, and a thickness is less than 0.1 mm. Proximal ends 60b of the electrical contact fingers 60 remain integral with the template 76, and are optionally intentionally bent at the tip for spring contact with wires (not shown) originating from the TEM. The distal tips 60a, which are disposed in the region covered by the U-shaped recess of the frame 66, are also slightly bent so that the electrical contact fingers 60 cannot move once clamped, and to promote contact with the MEMS device 62. Screws (not shown) are used to tighten the baseplate 64, frame 66 and end plate 68 to clamp the electrical contact fingers 60 therebetween, at which time the electrical contact fingers may be released from the remainder of the electrical contact template 76. For example, as illustrated in FIG. 3, scissors may be used to sever the electrical contact fingers 60 from the electrical contact template 76.

When the MEMS device 62 is relatively large, another method provides for through-holes disposed on the baseplate 64 where the electrical contact fingers 60 will be aligned. The electrical contact fingers 60 may then be positioned using the Torr Seal to glue the electrical contact fingers 60 to the baseplate 64 through the through-holes 80, and then release the electrical contact fingers from the electrical contact template 76.

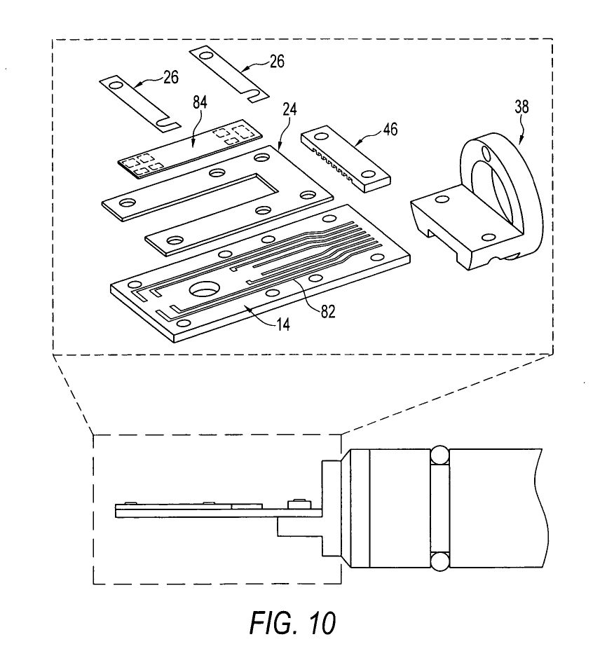

To further demonstrate the vast variety of configurations that the electrical contact fingers 16 may potentially assume, FIG. 10 is provided to illustrate a third exemplary embodiment of the invention. As illustrated in FIG. 10, the baseplate 14, frame 24 end plate 46 and retainers 26 are preferably similarly configured as the embodiments in FIGS. 1-9. However, the electrical contact fingers 82 include an alternative configuration to corresponding to the MEMS device 84 contemplated for use with this embodiment.

Experiments, Results and Discussion

A MEMS-based nanocalorimeter was mounted on the TEM holder. Bi films of varying thickness were deposited on the sensors beforehand, by thermal evaporation in a vacuum of ˜5×10⁻⁸ torr.

The voltage drop across the metal strip of the MEMS calorimeter and the current I through it are measured during dc electrical pulse. Current is determined by measuring the voltage drop across a series resistor of known value. The power P dissipated in the nanocalorimeter as a function of time t is given as:
P(t)=V(t)I(t)

Resistance R is a function of the temperature T of the sensor, and is calibrated for each sensor before the experiment. R is measured by the four-point method and can be calculated by
R(t)=V(t)/I(t)

The heat capacity C_{P} can then be determined from

$${C}_{p} ( t ) = P ( t ) {( \frac{ⅆ T}{ⅆ t} )}^{- 1}$$

C_{P}(t) is transformed to C_{P}(T) using T(t).

The heating rates achievable with this device are very high, in the range from 3×10⁴° C./s up to 10⁶° C./s. The heating cycle lasts for only about 10 ms. Fast heating reduces heat loss, and makes the measurement conditions close to adiabatic. By controlling I(T), the heating rate can be adjusted. A constant, small I can be used to heat the sensor for very long periods of time, essentially turning this calorimeter into a heating stage. The cooling rate is also quite high, −3×10³° C./s, due to the low thermal mass of the system. Thus, operating this MEMS-based calorimeter in the TEM offers a range of heating rate experiments unachievable with traditional heating stages.

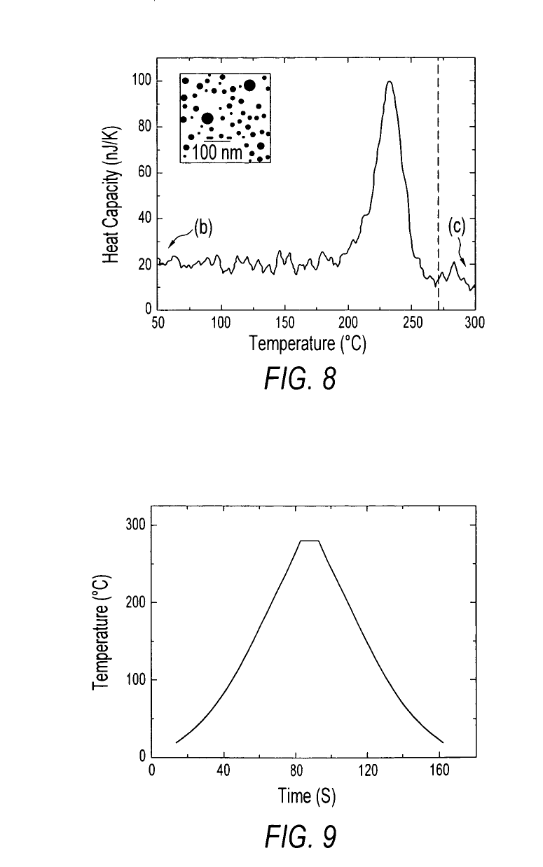

In situ melting experiments using bismuth particles with diameters in the range of 5-50 nm have been performed. A Bi film with a nominal thickness of 4 nm was thermally evaporated onto the SiNₓ membrane; in situ annealing causes the film to de-wet from the substrate and form spherical particles. In these experiments, a direct current (dc) electric current pulse is applied to the nanocalorimeter, rapidly increasing the temperature of the sensor wire and surrounding area. Heat capacity data for this sample are provided in FIG. 8. These particles had an average radius of ˜10 nm. Because of the size-dependent melting that occurs in this size regime, the melting temperature in FIG. 8 was measured to be 233° C., well below the bulk melting temperature of Bi, 271° C.

In addition to direct imaging of the Bi particles, the structure of the particles can be characterized by selected-area electron diffraction (SAED). Near room temperature, the particles are crystalline, and diffraction spots are clearly visible. During the calorimetric scans, the temperature increases above the Bi melting point, and the diffraction spots disappear indicating melting of the particles. Upon cooling, the diffraction spots reappear in random positions along the original Bi diffraction rings indicating crystallization from a molten state.

By using smaller currents, this calorimeter can be turned into a precision microheater. In this case, the power applied to the device is ramped until the desired temperature is reached. The temperature can be held for any length of time. An example of this mode of operation is shown in FIG. 9, where the temperature was increased from ambient to 280° C. and held for 10 s. The heating and cooling rates were both ˜120° C./s, but can be adjusted to nearly any rate by the user.

This mode of operation is different from other TEM heating stages in that only a small area is increasing in temperature. This mode can also make use of the high heating and cooling rates possible with the MEMS device. It would, for example, be possible to heat a sample, cool it rapidly (up to 3000° C./s), and examine a quenched-in microstructure.

Using this mode of operation, the size-dependent melting effect is directly observed.

Thus, the specimen holder allowed the use of MEMS sensors and actuators inside of a TEM, allowing the versatility of MEMS devices to be exploited while maintaining the full capabilities of the TEM. A MEMS-based nanocalorimeter was successfully operated in situ, demonstrating a capability of reaching heating rates in the range from 3×10⁴° C./s up to 10⁶° C./s. Size dependent melting experiments on bismuth nanoparticles were performed simultaneously with TEM imaging and diffraction, demonstrating that the MEMS device functions reliably during TEM observations. Operating a MEMS-based device in the TEM has been demonstrated to offer a range of heating experiments unachievable with traditional heating stages.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention.

What is claimed is:

1. A device holder for use with a standard holder body of a transmission electron microscope for use with in situ microscopy of both static and dynamic mechanisms, where the TEM is electrically coupled to said device holder via one or more wires extending from the holder body, said device holder comprising:
a baseplate;
a frame having an opening sized and configured to align a MEMS device;
a retainer to clamp said frame and said baseplate in alignment;
at least one electrical contact finger held between said baseplate and said frame, said contact finger including a first end disposed in the opening of the frame and biased upward to contact the MEMs device, said contact finger being aligned in a predetermined position such that said first end contacts a contact pad of the MEMs device; and
an end plate to hold the one or more wires in electrical contact with a second end of said at least one electrical contact finger.

2. The device holder of claim 1 further comprising from between one and eight electrical contact fingers, wherein a number of electrical contact fingers are provided to correspond to a number of contact pads of the MEMS device.

3. The device holder of claim 1 wherein said opening is generally rectangular in shape to accommodate a generally rectangular MEMS device having contact pads disposed on an underside thereof.

4. The device of claim 1 wherein said end plate further comprises a plurality of grooves along an underside thereof to maintain electrical contact between said second end of said electrical contact fingers and the wires extending from the holder body.

5. The device of claim 1 wherein said second end of said at least one electrical contact finger is biased upwardly to contact the one or more wires.

6. The device holder of claim 1 further comprising a connector configured to lockingly engage an underside of said baseplate and said end plate to couple said device holder to the TEM.

7. The device holder of claim 1 further comprising said second ends of said electrical contact fingers being biased upwardly to contact the wires extending from the holder body.

8. The device holder of claim 6 wherein said connector, said baseplate and said frame are configured to have dimensions to position the MEMS device at a eucentric position in the TEM.

9. The device holder of claim 6 further comprising a predetermined number of shims disposed between said baseplate and a platform of said connector to make fine adjustments to a height of the MEMS device.

10. A TEM microscope comprising a device holder according to claim 1.

11. A method of fabricating a MEMS-based device holder for use with a standard holder body of a transmission electron microscope for use with in situ microscopy of both static and dynamic mechanisms, said method comprising:
obtaining a MEMS device having predetermined dimensions and contact pads disposed thereon;
providing a baseplate and a frame having an opening to align the MEMs device;
defining at least one spring contact finger that is free on one end in an electrical contact template; and
clamping the template between the base plate and the frame such that the at least one spring contact finger aligns with contact pads of the MEMs device.

12. The method of claim 11, further comprising a step of separating a remainder of the electrical contact template from the at least one spring contact.

13. The method of claim 11 further comprising configuring the one end of the at least one spring contact finger to be biased upwardly.

14. The method of claim 11 further comprising defining a number of spring contact fingers corresponding to a number of contact pads disposed on the MEMS device.

15. The method of claim 11 further comprising boring through-holes on the baseplate for aligning the electrical contact fingers.

16. The method of claim 15 further comprising aligning the electrical contact fingers with the baseplate by reference to the through-holes.

17. A device holder for use with a standard holder body of a transmission electron microscope (TEM) for use with in situ microscopy of both static and dynamic mechanisms, where the TEM is electrically coupled to said device holder via one or more wires extending from the holder body, said device holder comprising:
means for holding and align a MEMS device in a predetermined position; and
spring contact finger means for contacting a contact pad of a MEMs device held by said means for holding.

18. The device holder of claim 17 wherein said means for holding and aligning a MEMS device comprise a baseplate coupled to a frame, wherein said frame includes a U-shaped opening configured to receive the MEMS device.

19. The device holder of claim 18 wherein said spring contact finger means comprise at least one electrical contact finger held between said baseplate and said frame.

20. The device holder of claim 19 wherein said at least one contact finger including a first end disposed in said opening of said frame and biased upward to contact the MEMs device, said contact finger being aligned in a predetermined position such that said first end contacts a contact pad of the MEMs device.
